(19) United States
(12) Patent Application Publication
(10) Pub. No.: US 2013/0243047 A1
(43) Pub. Date: Sep. 19, 2013

(54) HART Communication-Compatible Instrument

(71) Applicant: AZBIL CORPORATION, Tokyo (JP)

(72) Inventor: Shin SUZUKI, Tokyo (JP)

(73) Assignee: AZBIL CORPORATION, Tokyo (JP)

(21) Appl. No.: 13/795,065

(22) Filed: Mar. 12, 2013

(30) Foreign Application Priority Data
Mar. 19, 2012 (JP) 2012-062018

(51) Int. Cl. H04L 5/14

(52) U.S. Cl. CPC H04L 5/143
USPC 375/219

(57) ABSTRACT

A HART communication-compatible device having a HART communication function for transmitting and receiving HART communication signals generated through superimposing an AC signal that is a combination of 1200 Hz and 2200 Hz frequency signals onto a DC signal of between 4 and 20 mA, including a receiving portion for receiving a HART communication signal, a signal detecting portion for detecting an AC signal of the HART communication signal using the HART communication signal received by the receiving portion; and an indicator portion for indicating, during the interval over which the AC signal is detected by the signal detecting portion, that an AC signal is detected.

### CROSS-REFERENCE TO RELATED APPLICATIONS

This application claims priority to Japanese Patent Application No. 2012-062018 filed Mar. 19, 2012. This application is incorporated herein by reference.

### FIELD OF TECHNOLOGY

The present invention relates to a HART communication-compatible device.

### BACKGROUND

In the field of controlling manufacturing processes, manufacturing processes are run and controlled by arranging a large number of devices (for example, sensor instruments and devices such as valve positioners, and the like, in the plant, and collecting into a system the signals sent from these devices. In recent years, devices (hereinafter termed “HART communication-compatible devices”) that are provided with the HART (Highway Addressable Remote Transducer) communication function have been used as the devices that are arranged within the plant. These HART communication-compatible devices input and output signals (hereinafter termed “HART communication signals”) that are produced by superimposing AC signals, wherein logic of digital signals has been converted through assignment to frequency signals of 2200 Hz and 1200 Hz, onto DC signals of between 4 and 20 mA that indicate a measured value or a control value. Systems that use HART communication-compatible devices are disclosed in Japanese Unexamined Patent Application Publication 2003-186503 and Japanese Patent 4129715.

Typically, when HART communication-compatible devices are arranged within a plant, a variety of parameters (setting information) are set depending on the manufacturing processes within the plant, to operate in accordance with the details of those settings. In a system that controls HART communication-compatible devices, the setting information that is set in the individual devices is controlled centrally by a device management device, and the individual devices are monitored based on that information.

However, while the setting information for a HART communication-compatible device can be changed from the device management device side, it is also possible to use a terminal, such as a communicator, to modify the setting information within the work area wherein the HART communication-compatible device is disposed. Moreover, while it is possible to provide notification to the device management device side that there has been a modification when setting information has been changed on the work floor side, it is not possible to provide notification regarding how the setting information was changed. In this case, it is not possible to ascertain all of the setup information that has been changed without comparing all of the work floor-side setup information with the control-side setup information. Consequently, when setup information has been changed on the work floor side, there is the possibility that a discrepancy may occur between the setup information in the HART communication-compatible device and the setup information that is controlled by the device management device, which will prevent the device management device from properly monitoring the HART communication-compatible device.

The present invention is to solve the problem area set forth above with the conventional technology, and the object thereof is to provide a HART communication-compatible device wherein it is possible to create awareness among the staff on the work floor that there is centralized control by the device management device.

### SUMMARY

A HART communication-compatible device according to examples of the present invention, is a HART communication-compatible device having a HART communication function for transmitting and receiving HART communication signals generated by superimposing a first signal and a second signal, including a receiving portion for receiving the HART communication signal; a signal detecting portion for detecting the second signal using the HART communication signal received by the receiving portion; and an indicator portion for indicating that the second signal has been detected, over the interval over which the second signal is detected by the signal detecting portion.

When this structure is used, it is possible to indicate that HART communication is in the process while a HART communication signal is being received from the device management device by the HART communication-compatible device, and thus the staff on the work floor is able to confirm that the HART communication-compatible device is being monitored by the device management device. This makes it possible to trigger awareness among the staff so as to not change, on the work floor side, the setting information of the HART communication-compatible device.

A received signal evaluating portion for evaluating whether or not a HART communication signal that has been received by the receiving portion is a request signal from a controlling device may also be provided, making it possible for the indicator portion to display that a request signal is being received when the second signal is detected by the signal detecting device when there has been an evaluation, by the received signal evaluating portion, that the HART communication signal is a request signal.

Doing so makes it possible to display that a request signal is being received, when an evaluation is performed as to whether or not a received signal from a controlling device is a request signal, and that it is a request signal, even if the noise is detected by the signal detecting device, thus making it possible to cause the staff to be aware that signal that is currently being received is not noise, but rather a proper signal from the device monitoring device.

Whether or not a HART communication signal that has been received by the receiving portion is a request signal from a controlling device is evaluated by the received signal evaluating portion, making it possible for the indicator portion to display that a request signal addressed to a different device is being received when the second signal is detected by the signal detecting device when there has not been an evaluation, by the evaluating portion, that the HART communication signal is a request signal addressed to the local device.

This make it possible to evaluate whether or not a received signal is a request signal addressed to the local device, even if the HART communication-compatible device has been changed on the work floor side, making it possible to indicate that a request signal addressed to another device is being received, if the request signal is not addressed to the local device, thus making it possible to produce an awareness among the staff that, at that point in time, the HART communication-compatible device is not being controlled properly by the device management device side.

The indicator portion may further display information regarding the command while the second signal is detected by the signal detecting portion when a command is included in the request signal.

Doing so makes it possible to ascertain, even on the work floor side, the details of the operation on the device management device side (for example, writing or reading setting information).

A transmitting portion for transmitting the HART communication signal, and a transmission signal evaluating portion for evaluating whether or not the HART communication signal transmitted by the transmitting portion is a response signal to the control device may further be provided, where, when it is evaluated by the transmission signal evaluating portion that the HART communication signal is the response signal, the indicator may indicate, while the HART communication signal is being transmitted from the transmitting portion, that a response signal is being transmitted.

The examples of the present invention can provide a HART communication-compatible device that can produce awareness in the staff of a work floor that there is centralized control by a device management device.

### BRIEF DESCRIPTIONS OF THE DRAWINGS

FIG. 1 is a diagram illustrating the structure of a device management system including a HART communication-compatible device according to an example.

FIG. 2 is a flowchart for explaining the operation of the HART communication-compatible device in the example.

### DETAILED DESCRIPTION

An example of the present invention is explained below in reference to the drawings. However, the example explained below is no more than an illustration, and does not exclude various modifications and applications to technologies not explicated below. That is, examples of the present invention can be embodied in a variety of modified forms, in the scope that does not deviate from the spirit and intent thereof.

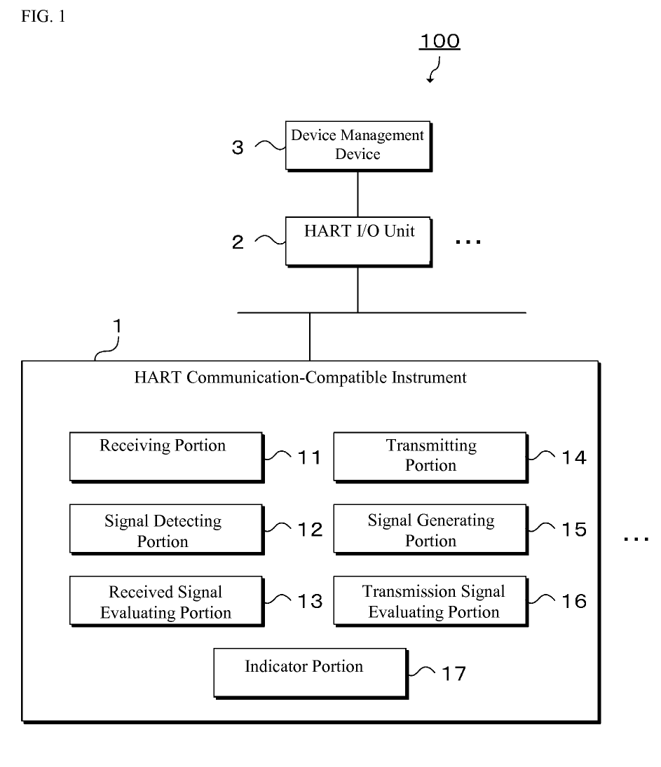

FIG. 1 is a diagram illustrating the structure of a device management system including a HART communication-compatible device according to an example of the present invention. As illustrated in FIG. 1, the device management system 100 is provided with a HART communication-compatible device 1, an input/output device having a HART communication function (hereinafter termed a HART I/O unit) 2, and a device management device 3.

The HART communication-compatible device 1 may be a device of a variety of types equipped within a plant. The HART communication-compatible device 1 may be a transmitting device for transmitting a flow rate, pressure, temperature, or the like, a positioner for changing/detecting the degree of opening of a valve such as a flow rate controlling valve or a pressure controlling valve, or an actuator for actuating a pump, a fan, or the like.

The HART communication-compatible device 1 in the present example may be set up with various types of parameters. The parameters of the HART communication-compatible device 1 can be changed from the device management device 3 side, or may be changed from the work floor side, where the HART communication-compatible device 1 is located, using a terminal such as a communicator. The communicator is a terminal having a function for setting a parameter of a HART communication-compatible device 1, a function for adjusting the output thereof, a function for checking data, and the like. The communicator is used by connecting a communication cable between the HART I/O unit 2 and the HART communication-compatible device 1.

The HART communication-compatible device 1 is provided with a HART communication function, to input and output HART communication signals. The HART communication signals are signals produced by superimposing an AC signal (a second signal) wherein logic of a digital signal is converted through assignment to frequencies of 2200 Hz and 1200 Hz, onto a DC signal (a first signal) of between 4 and 20 mA.

The aforementioned DC signal of between 4 and 20 mA is a signal indicating one variable that is set for each HART communication-compatible device 1. The variable value is a measurement value such as, for example, a flow rate, a pressure, or a temperature, or a control value such as a degree of valve opening. The digital signal is a signal corresponding to various types of data that can be collected within the HART communication-compatible device 1. The various data may be, for example, process information within the HART communication-compatible device 1, or diagnostic information for hardware incorporated within the HART communication-compatible device 1.

The HART communication-compatible device 1 produces a HART communication signal through, for example, the following. First the HART communication-compatible device 1 converts a digital signal expressed by, for example, 0 and 1, into an AC signal by assignment, respectively, to a 2200 Hz frequency signal and a 1200 Hz frequency signal. Following this, the HART communication-compatible device 1 superimposes the AC signal, after conversion, onto a DC signal of between 4 and 20 mA that expresses a measured value, a control value, or the like. The HART communications signals are produced thereby.

The HART I/O unit 2 is an input/output device for sending and receiving HART communication signals between HART communication-compatible devices 1 and also for sending and receiving digital signals to and from the device management device 3. The HART I/O unit 2 generates through, for example, the following, a DC signal of between 4 and 20 mA and a digital signal from the HART communication signal. First the HART I/O unit 2 separates the HART communication signal into an AC signal that combines a 2200 Hz frequency signal and a 1200 Hz frequency signal, and a DC signal of between 4 and 20 mA. Following this, the HART I/O unit 2 converts the AC signal, after separation, into digital signals expressed by 0 and 1.

The device management device 3 periodically (for example, once per second) sends a request signal to each HART communication-compatible device 1 through the HART I/O unit 2, and receives response signals in response to the request signals. Based on the response signals received, the device management device 3 evaluates the state of execution of the processes of the HART communication-compatible devices 1, failure states of hardware incorporated into the HART communication-compatible devices 1, required timing for maintenance and repairs of the HART communication-compatible devices 1, and so forth. The device management device 3 displays the evaluation results on a monitor (not shown). Doing so enables the administrator to monitor the status of the HART communication-compatible devices 1.

The functional structure of a HART communication-compatible device 1 can be explained in reference to FIG. 1. As illustrated in FIG. 1, the HART communication-compatible device 1 has, for example, a receiving portion 11, a signal detecting portion 12, a received signal evaluating portion 13, a transmitting portion 14, a signal generating portion 15, a transmission signal evaluating portion 16, and an indicator portion 17. The receiving portion 11 receives the HART communication signal.

The signal detecting portion 12 uses the signal received by the receiving portion 11 to detect the AC signal (the carrier) included in the HART communication signal. Specifically, the signal detecting portion 12 detects the AC signal included in the HART communication signal through passing only AC signals with frequency bands in the vicinity of 1200 Hz through the vicinity of 2200 Hz, of the signals received by the receiving portion 11. The signal detecting portion 12, while detecting the AC signals from the vicinity of 1200 Hz to the vicinity of 2200 Hz, outputs, to the indicator portion 17, a signal indicating that an AC signal included within the HART communication signal is detected.

The received signal evaluating portion 13 evaluates whether or not a signal that has been received by the receiving portion 11 is a request signal from the device management device 3. The evaluation of whether or not it is a request signal may be performed through, for example, the following.

The device management device 3, when transmitting a request signal, stores, in a frame type item of a frame start delimiter field of the HART communication signal, a code indicating that the signal is a request signal. Consequently, the received signal evaluating portion 13 evaluates that a received signal is a request signal from the device management device 3 when the code that indicates that the signal is a request signal is stored in the frame region corresponding to the frame type item, of the signal received by the receiving portion 11.

The received signal evaluating portion 13 evaluates whether or not the signal received by the receiving portion 11 is a request signal to the local device. Whether or not the signal is a request signal to the local device can be evaluated, for example, as follows.

When transmitting a request signal, the device management device 3 stores, in the destination address item of the address field of the HART communication signal, an address of the HART communication-compatible device 1 that is the transmission destination. Consequently, the received signal evaluating portion evaluates the received signal to be a request signal addressed to the local device when the address of the local device is stored in the frame region corresponding to the transmission destination address item of the signal when the signal received by the receiving portion 11 is a request signal from the device management device 3.

On the other hand, the received signal evaluating portion 13 evaluates that the received signal is a request signal to another device when the signal received by the receiving portion 11 is a request signal from the device management device 3 and the address of the local device is not stored in the frame region corresponding to the transmission destination address item of that signal.

The signal generating portion 15 generates an AC signal based on the HART communication signal. For example, when generating the AC signal corresponding to the response signal to the device management device 3, the signal generating portion 15 generates the response signal from the zeros and ones, and then assigns respective 2200 Hz frequency signals and 1200 Hz frequency signals to the response signal expressed in zeros and ones to generate the AC signal.

The transmitting portion 14 superimposes, onto the 4 through 20 mA DC signal, the AC signal generated by the signal generating portion 15, to generate the HART communication signal, and sends that HART communication signal addressed to the device management device 3.

The transmission signal evaluating portion 16 evaluates whether or not the signal sent from the transmitting portion 14 is a response signal to the device management device 3. The evaluation of whether or not it is a response signal to the device management device 3 may be performed through, for example, the following.

The signal generating portion 15, when generating a response signal, stores, in a frame type item of a frame start delimiter field of the response signal, a code indicating that the signal is a response signal. Consequently, the transmission signal evaluating portion 16 evaluates that a transmission signal is a response signal to the device management device 3 when the code that indicates that the signal is a response signal is stored in the frame type item, of the signal transmitted by the transmitting portion 14.

The indicator portion 17 displays, using a system that is discernible by the staff in the work floor, that the HART communication-compatible device 1 is performing HART communication with the device management device 3 while a HART communication signal is being received from the device management device 3. Whether or not a HART communication signal has been received from the device management device 3 can be evaluated by whether or not an alternating current, included in the HART communication signal, has been detected by the signal detecting portion 12. That is, it is possible to evaluate that a HART communication signal has been received from the device management device 3 while the AC signal that is included in the HART communication signal is detected by the signal detecting portion 12.

The display methods of (1) through (4), below, for example, can be used as display methods that can be discerned by the staff in the work floor:

(1) A message or icon indicating that HART communication is in process being displayed on an LCD (liquid crystal display);

(2) A special display indicating that HART communication is in process being displayed on an LCD. As the particular display, text, graphics, or the like going around the edge of the LCD, for example, may be used.

(3) Illumination or flashing of the backlight of the LCD in a color that indicates that HART communication is in process; or

(4) Illumination or flashing of an LED (light emitting diode) indicating that HART communication is in process.

In this way, it is possible for the staff to become aware that the HART communication-compatible device 1 is being monitored by the device management device 3, through the display that HART communication is in process during the interval wherein the HART communication signal from the device management device 3 is being received by the HART communication-compatible device 1.

Moreover, the indicator portion 17 may be modified through, for example, appropriate combinations of the display methods set forth above depending on the detail of the signals being sent and received. For example, as details of signals being sent and received there are (1) through (3), below:

(1) The Signal is a Request Signal

In this case, when there is an evaluation by the received signal evaluating portion 13 that a received signal is a request signal from the device management device 3, the indicator portion 17 displays that a request signal is being received during the interval over which the alternating signal included in the HART communication signal is detected by the signal detecting portion 12.

Here, even when an AC signal that is included in the HART communication signal is detected by the signal detecting portion 12, there is the possibility that this received signal is noise having a frequency between the vicinity of 1200 Hz and the vicinity of 2200 Hz. Consequently, it is possible to cause the staff to be aware that the signal currently being received is a proper signal from the device management device 3, as opposed to noise, by displaying that a request signal is being received.

Moreover, because a command is stored in the request signal, information pertaining to that command (for example, the command number or detail thereof) may be displayed as well. Doing so makes it possible for the work floor side as well to understand the detail of the operations (for example, writing or reading parameters, like), by the device management device 3 side.

(2) The Signal is a Request Signal Addressed to Another Device

In this case, when there is an evaluation by the received signal evaluating portion 13 that a received signal is not a request signal to the local device, the indicator portion 17 indicates that a request signal addressed to another device is being received, during the interval over which the alternating current signal included in the HART communication signal is detected by the signal detecting portion 12.

Cases wherein request signals addressed to other devices are received include, for example, cases wherein a HART communication-compatible device 1 has been swapped on the factory side, and cases wherein a multi-drop connection is used. Consequently, indicating that a request signal addressed to another device is being received makes it possible for the staff to discern that, at that point in time, the HART communication-compatible device 1 is not under proper control by the device management device 3 side.

(3) The Signal is a Response Signal

In this case, when there is an evaluation by the transmission signal evaluating portion 16 that the transmission signal is a response signal to the device management device 3, the indicator portion indicates that a response signal is being transmitted, during the interval over which the HART communication signal is being transmitted from the transmitting portion 14.

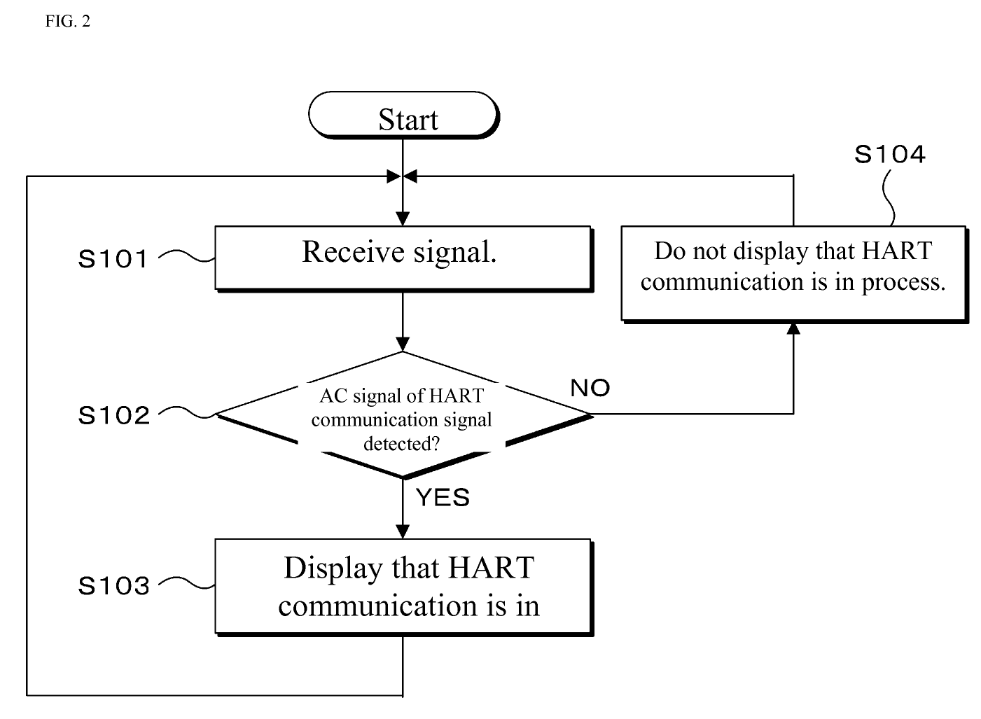

The operation of the HART communication-compatible device 1 according to the present example can be explained in reference to FIG. 2.

First the receiving portion 11 of the HART communication-compatible device 1 receives a HART communication signal (Step S101).

Following this, the signal detecting portion 12 of the HART communication-compatible device 1 uses the signal received in Step S101 to detect the AC signal included in the HART communication signal (Step S102).

If an AC signal included in the HART communication signal is detected from the received signal in Step S102 (Step S102: YES), then the indicator portion 17 of the HART communication-compatible device 1 displays on a displaying portion (such as an LCD or an LED) that HART communication is in process (Step S103). The processing then jumps to Step S101, above.

On the other hand, if no AC signal included in a HART communication signal is detected from the received signal in Step S102 (Step S102: NO), then the indicator portion 17 of the HART communication-compatible device 1 does not display that HART communication is in process (Step S104). Stated differently, if there is already a display that HART communication is in process, that display is canceled, but if there has been no display that HART communication is in process, this state wherein there is no display is maintained. The processing then jumps to Step S101, above.

As described above, the HART communication-compatible device 1 according to the present example makes it possible to display that HART communication is in process over the interval wherein the HART communication-compatible device 1 is receiving a HART communication signal from the device management device 3, thus making it possible for the work floor staff to discern that the HART communication-compatible device 1 is being monitored by the device management device 3. This can stimulate awareness among the staff so as to not modify, on the work floor side, the setting information of the HART communication-compatible device 1.

Because of this, the HART communication-compatible device 1 according to the present example and causes the staff to be aware that there is centralized control by the device management device.

We claim:

1. A HART communication-compatible device having a HART communication function transmitting and receiving HART communication signals generated by superimposing a first signal and a second signal, comprising:
a receiving portion receiving the HART communication signal;
a signal detecting portion detecting the second signal using the HART communication signal received by the receiving portion; and
an indicator portion indicating that the second signal has been detected, over the interval over which the second signal is detected by the signal detecting portion.

2. The HART communication-compatible device as set forth in claim 1, further comprising:
a received signal evaluating portion evaluating whether or not the HART communication signal received by the receiving portion is a request signal from the controlling device, wherein:
if there is an evaluation by the received signal evaluating portion that the HART communication signal is a request signal, the indicator portion indicates that a request signal has been received, over the interval over which the second signal is detected by the signal detecting portion.

3. The HART communication-compatible device as set forth in claim 2, further comprising:
the received signal evaluating portion evaluates whether or not the HART communication signal that has been received by the receiving portion is a request signal addressed to the local device; and
if it is evaluated by the evaluating portion that the HART communication signal is not a request signal to the local device, the indicator portion indicates that a request signal addressed to another device is being received, over the interval over which the second signal is detected by the signal detecting portion.

4. The HART communication-compatible device as set forth in claim 2, wherein:
if a command is included in the request, the indicator portion further displays information pertaining to the command, over the interval over which the second signal is detected by the signal detecting portion.

5. The HART communication-compatible device as set forth in claim 3, wherein:
if a command is included in the request, the indicator portion further displays information pertaining to the command, over the interval over which the second signal is detected by the signal detecting portion.

6. The HART communication-compatible device as set forth in claim 1, further comprising:
a transmitting portion transmitting a HART communication signal; and
a transmission signal evaluating portion evaluating whether or not the HART communication signal that is being transmitted by the transmitting portion is a response signal to the controlling device, wherein:
if there is an evaluation by the transmission signal evaluating portion that the HART communication signal is the response signal, the indicator portion indicates that the response signal is being transmitted, over the interval over which the HART communication signal is being transmitted by the transmitting portion.

7. The HART communication-compatible device as set forth in claim 1, further comprising:
the first signal is a DC signal of between 4 and 20 mA; and
the second signal is an AC signal wherein digital signal logic is expressed through assignment to different frequency signals.
